(19) United States
(12) Patent Application Publication
(10) Pub. No.: US 2025/0212072 A1
(43) Pub. Date: Jun. 26, 2025

(54) BASIC SERVICE SET TRANSITION MANAGEMENT ENHANCEMENT TO SIGNAL ADDING AND DELETING SPECIFIC LINK SET FOR MULTI-LINK DEVICES

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 18/989,599

(22) Filed: Dec. 20, 2024

Related U.S. Application Data
(60) Provisional application No. 63/612,610, filed on Dec. 20, 2023.

(51) Int. Cl. H04W 36/00; H04W 36/18; H04W 36/24

(52) U.S. Cl. CPC H04W 36/00835; H04W 36/18; H04W 36/24

(57) ABSTRACT

In one aspect, a method includes generating, by an access point multi-link device (AP MLD), a basic service set transition management (BTM) request frame including at least one neighbor report element identifying a recommended roaming candidate AP MLD for a non-access point multi-link device (non-AP MLD) to roam to; updating, by the AP MLD, the BTM request frame to further include at least one element identifying at least one preferred operation corresponding to the recommended roaming candidate AP MLD in the at least neighbor report element; and sending, by the AP MLD, the BTM request frame to the non-AP MLD to perform roaming based thereon.

### CROSS-REFERENCE TO RELATED APPLICATION

This application claims priority to and the benefit of U.S. Prov. App. No. 63/612,610, filed on Dec. 20, 2023, which is expressly incorporated herein by reference in the entirety.

### TECHNICAL FIELD

The present technology pertains to wireless communication network, and more specifically, to signaling procedures for communication link management between non-access point multi-link devices and access-point multi-link devices in in a Wireless network.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11bc) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates a network diagram illustrating an example network environment of multi-link operation according to some aspects of the present disclosure.

FIG. 2B depicts an illustrative schematic diagram for connectivity of an access point (AP) multi-link device (MLD) with multiple affiliated APs to a non-AP MLD with multiple affiliated non-AP stations (STAs) according to some aspects of the present disclosure.

FIG. 2C illustrates an example of a seamless mobility domain according to some aspect of the present disclosure.

FIG. 3 illustrates an example structure of a Neighbor Report element according to some aspects of the present disclosure.

FIGS. 4A-C each illustrates an example event trace diagram according to some aspects of the present disclosure.

FIG. 5 illustrates an example flow-chart of method operations according to some aspects of the present disclosure.

FIG. 6 illustrates an example of a system for implementing certain aspects of the present disclosure according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Abbreviations

Access Point (AP)
Advanced Encryption Standard (AES)
Association and key management (AKM)
Basic service set (BSS)
Extended Service Set (ESS)
Extremely high throughput (EHT)
Fast Transition (FT)
Mobile Device Management (MDM)
Multi-Link Device (MLD)
Multi-link Operation (MLO)
Network Interface Device (NID)
Pairwise Master Key (PMK)
Pairwise Transient Key (PTK)
Robust Security Network Element (RSNE)
Seamless Mobility Domain (SMD)
Service Set Identifier (SSID)
Station (STA)
Wi-Fi Protected Access (WPA)
Wireless Local Area Network (WLAN)
Wireless LAN Controller (WLC)

Mobility Domain MLD (MDM), also Seamless Mobility Domain (SMD) refer to a logical entity including multiple AP MLDs to which a STA (a Wi-Fi client device or non-AP MLD) associates.

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Various technical features may be readily apparent to one skilled in the art from the following figures, descriptions, and claims.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed, or new mechanisms may be introduced to share the MLO information (e.g., related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features directed to improve the performance of Wi-Fi networks as the Multi-AP coordination is directed toward utilizing (distributed) coordination between different APs to reduce inter-Basic Service Set (BSS) interference for improved spectrum utilization in dense deployments, and the MLO supports high data rates and low latency by leveraging flexible resource utilization offered by the use of multiple links for the same device.

### Overview

In one aspect, a method includes generating, by an access point multi-link device (AP MLD), a basic service set transition management (BTM) request frame (BTM request frame) including at least one neighbor report element identifying a recommended roaming candidate AP MLD for a non-access point multi-link device (non-AP MLD) to roam to; updating, by the AP MLD, the BTM request frame to further include at least one element identifying at least one preferred operation corresponding to the recommended roaming candidate AP MLD in the at least neighbor report element; and sending, by the AP MLD, the BTM request frame to the non-AP MLD to perform roaming based thereon.

In another aspect, the at least one preferred operation corresponds to an add link action for adding a respective link associated with the AP MLD or another AP MLD.

In another aspect, the at least one preferred operation corresponds with a delete link action for deleting a respective link associated with the AP MLD or another AP MLD for roaming.

In another aspect, the at least one preferred operation corresponds with an exclude link action that indicates excluding a respective link associated with the AP MLD or another AP MLD.

In another aspect, the at least one preferred operation is specified in a reconfiguration operation type (sub) field of a reconfiguration multi-link element included in the at least one neighbor report element.

In another aspect, the recommended roaming candidate AP MLD and the AP MLD both belong to the same seamless mobility domain.

In another aspect, the method further includes updating, by the AP MLD, the BTM request frame to further include a respective reason code corresponding to the at least one preferred operation.

In another aspect, the BTM request frame is generated based upon receiving, by the AP MLD from the non-AP MLD, a BTM query frame including at least one neighbor report element identifying a preferred roaming candidate AP MLD, and at least one optional element identifying at least one preferred operation corresponding to the preferred roaming candidate AP MLD.

In another aspect, the at least one preferred operation is specified in a reconfiguration operation type (sub) field using a value from 5 to 15, or any unused value, and wherein the at least one neighbor report element is Reconfiguration Multi-link element having a value selected from a set of values including a first value through a second value, or any unused value, and wherein the first value is 202 and the second value is 220.

In one aspect, an access point multi-link device (AP MLD) includes at least one memory configured to store computer-readable instructions and at least one processor communicatively coupled with the at least one memory. The at least one processor is configured to execute the computer-readable instructions to generate a basic service set transition management (BTM) request frame (BTM request frame) including at least one neighbor report element identifying a recommended roaming candidate AP MLD for a non-access point multi-link device (non-AP MLD) to roam to; update the BTM request frame to further include at least one optional element identifying a preferred operation corresponding to the recommended roaming candidate AP MLD in the at least neighbor report element; and send the BTM request frame to the non-AP MLD to perform roaming based thereon.

In one aspect, a non-transitory computer-readable media includes computer-readable instructions stored thereon, which, when executed by at least one processor of an access point multi-link device (AP MLD), cause the AP MLD to generate a basic service set transition management (BTM) request frame (BTM request frame) including at least one neighbor report element identifying a recommended roaming candidate AP MLD for a non-access point multi-link device (non-AP MLD) to roam to; update the BTM request frame to further include at least one optional element identifying a preferred operation corresponding to the recommended roaming candidate AP MLD in the at least neighbor report element; and send the BTM request frame to the non-AP MLD to perform roaming based thereon.

### EXAMPLE EMBODIMENTS

In Wi-Fi 8, support for seamless or smooth roaming capability is a strong consideration to improve Wi-Fi roaming quality. In particular, to support smooth roaming or mobility in a campus wide Wi-Fi network, Wi-Fi client devices can create an association with the campus-network (also referenced herein as an ESS, an NID, and/or an MDM) instead of creating an association with an individual AP MLD. The ESS might be represented by a mobility domain or a global network (e.g., NID). Further, within a single mobility domain, there can be multiple “sub-mobility domains,” where each of the multiple “sub-mobility domains” may map to a single campus.

Currently, the Wi-Fi client device creates its association with the ESS network represented by a (sub) Mobility Domain Multi-Link Device (MLD), instead of associating with a single AP MLD within the ESS. Such an architecture can enable the Wi-Fi client device to roam seamlessly between AP MLDs without requiring reassociation and reestablishment of contexts with each new AP MLD. Further, because the Wi-Fi client device associates with the Mobility Domain MLD covering all the AP MLDs of the ESS, such an architecture also reduces roaming time to realize seamless roaming.

Generally, management frames such as BSS Transition Management (BTM) frames can trigger roaming from the AP side. However, the BTM frame does not support indicating one or more specific link sets, each including one or more links, which are either one or more link sets recommended to be added by the non-AP MLD and/or one or more link sets recommended to be deleted by the non-AP MLD. Currently, the BTM only provides recommendation for the links or neighboring APs. Accordingly, the BTM frame may be enhanced to add a Basic ML element to indicate recommendation for specific links of an AP MLD. Additionally, or alternatively, the BTM frame may be enhanced to indicate which set of links to be added and/or which set of links to be deleted by the non-AP MLD when the non-AP MLD is roaming across AP MLDs within a Mobility Domain MLD for Wi-Fi 8. Enhancement proposed herein addresses the shortcomings of the current management frame, such as the BTM frame. However, the enhancements proposed herein are not limited to the BTM frame but can be supported or implemented in any management frame.

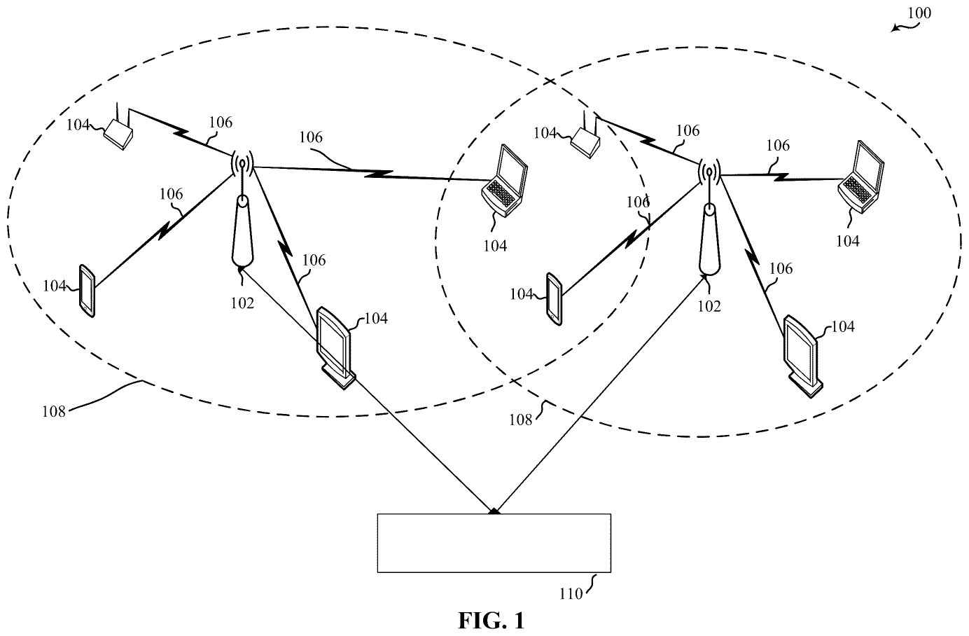

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a non-AP MLD, and/or a non-AP MLD. As illustrated, wireless communication network 100 also may include multiple AP actors such as AP actors 102 (may also be referred to as simply AP). AP actors 102 can be coupled to one another through a switch 110. While AP actors 102 are shown as being coupled to one another through switch 110, wireless communication network 100 can provide another device that allows the coupling of multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of AP actors 102 and an associated set of STA actors (e.g., STA actors 104) may be referred to as a basic service set (BSS), which is managed by a respective AP actor of AP actors 102. FIG. 1 additionally shows an example coverage area 108 of the each of AP actors 102, which may represent a basic service area (BSA) of wireless communication network 100. As illustrated, three of STA actors 104 are within the BSA of each of AP actors 102. The BSS may be identified to users by a service set identifier (SSID), where the BSS might be one of many in the SSID. The BSS may be identified to other devices by a unique (or substantially unique) basic service set identifier (BSSID). One or more of AP actors 102 periodically broadcasts beacon frames (“beacons”) including the BSSID to enable STA actors 104 within wireless range of AP actors 102 to “associate” or re-associate with AP actors 102 to establish a respective communication link of communication links 106 (hereinafter also referred to as a “Wi-Fi link”), or to maintain communication links 106, with AP actors 102. For example, the beacons may include an identification of a primary channel used by respective AP actor of AP actors 102 as well as a timing synchronization function for establishing or maintaining timing synchronization with AP actors 102. AP actors 102 may provide communication links 106 to STA actors 104 and therefore access to external networks. While the example has been described in regard to AP actors 102 and STA actors 104, the present disclosure extends such that an AP actor may provide access to external networks to various STA actors in a WLAN via communication links 106.

To establish communication links 106 with any one of AP actors 102, each of STA actors 104 is configured to perform passive or active scanning operations (“scans”) on frequency channels in one or more frequency bands (for example, the 2.4 GHZ, 5 GHZ, 6 GHZ or 60 GHZ bands). To perform passive scanning, STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, STA actors 104 generate and sequentially transmits probe requests on each channel to be scanned and listens for probe responses from AP actors 102. STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to STA actors 104 at the culmination of the association operations, which selected AP actor of AP actors 102 uses to improve the efficiency of certain signaling to the STA actors 104.

The present disclosure modified the WLAN radio and baseband protocols for the PHY and medium access controller (MAC) layers. AP actors 102 and STA actors 104 transmit and receive wireless communications (hereinafter also referred to as “Wi-Fi communications”) to and from one another in the form of PHY protocol data units (PPDUs). AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

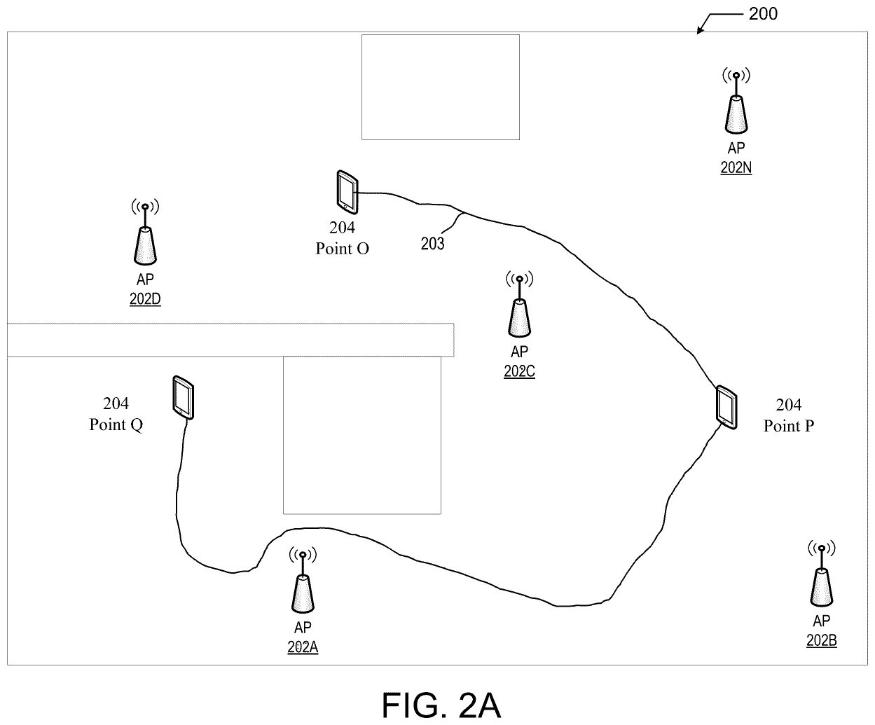

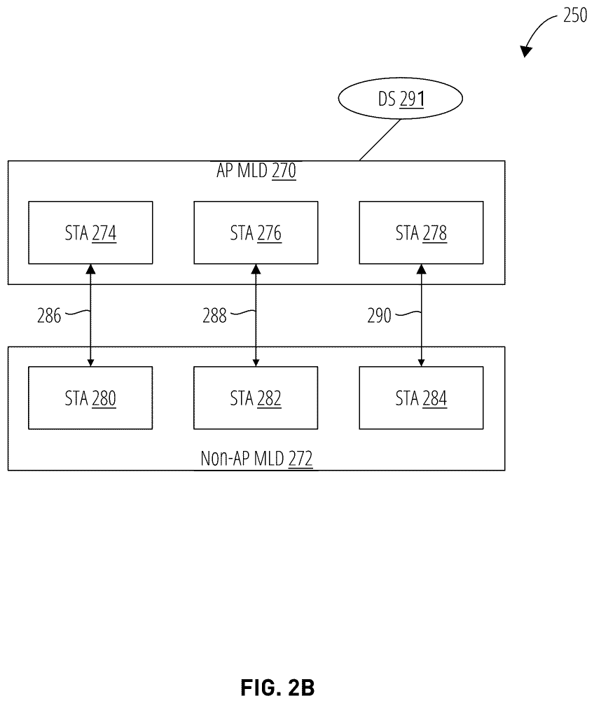

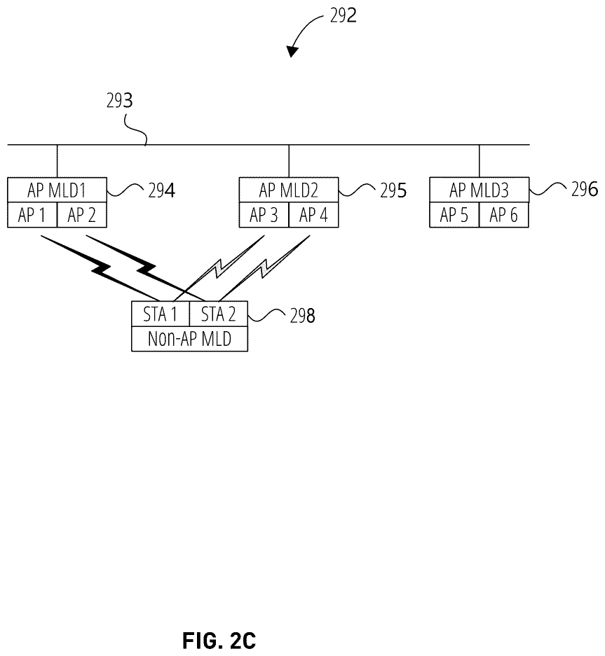

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 200 includes AP actors 202A, 202B, 202C, 202D, 202N. Each of the AP actors 202A, 202B, 202C, 202D, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, 202D, 202N may substantially overlap with the coverage of another AP actor of the AP actors 202A, 202B, 202C, 202D, 202N.

As illustrated by line 203, STA actor 204 can move from point O to point P to point Q. When a STA actor 204 is moving around on a given floor, one or more of AP actors 202A, 202B, 202C, 202D, 202N can be considered to be nearest to STA actor 204. Nearest as used in relation to AP actors 202A, 202B, 202C, 202D, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, schematic diagram 250 shows two multi-link logical entities AP MLD 270 and Non-AP MLD 272 are shown. AP MLD 270 may include physical and/or logical affiliated AP such as AP 274, AP 276, and AP 278 operating in different channels and typically different frequency bands (e.g., 2.4 GHZ, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 291, which is a system used to interconnect a set of BSSs to create an extended service set (ESS).

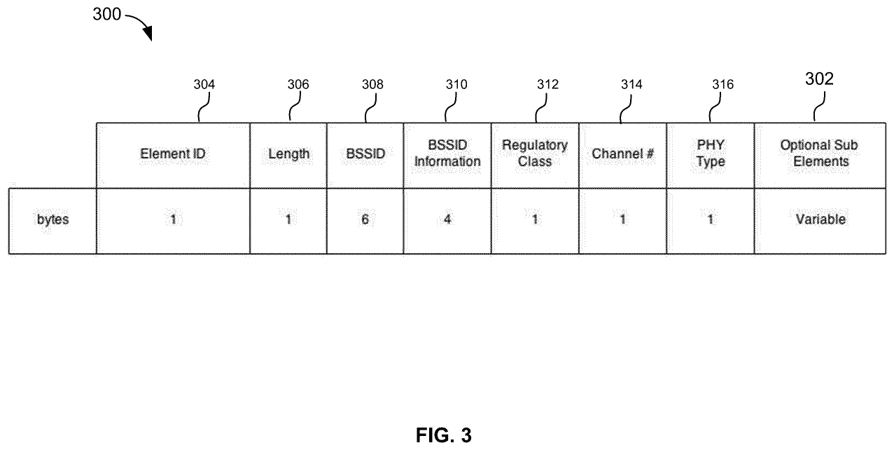

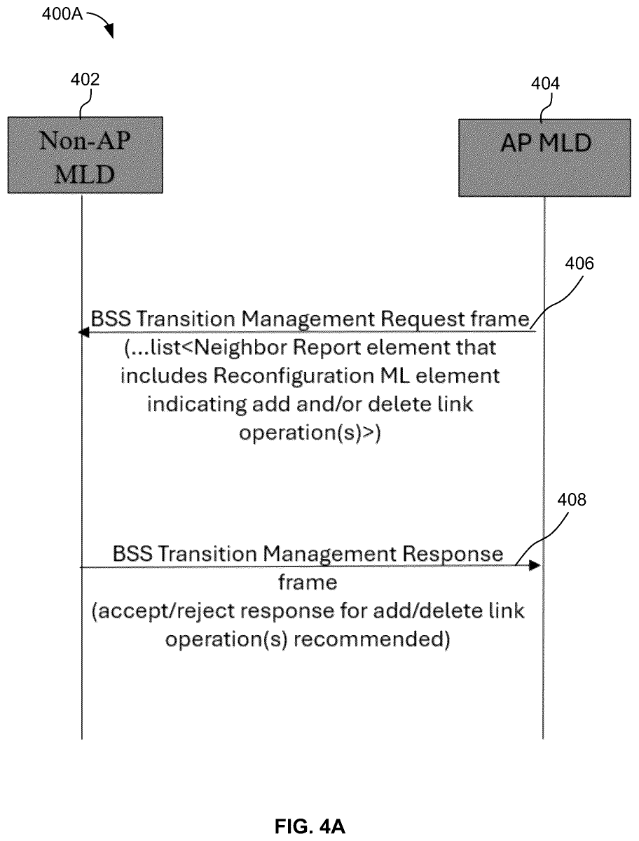

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4, and 5.

FIG. 2C illustrates an example of a seamless mobility domain according to some aspect of the present disclosure. FIG. 2C illustrates an example architecture of a Seamless Mobility Domain (SMD) shown as SMD 292 that includes a DS 293 that is a logically connected entity that includes AP MLD1 294, AP MLD2 295, and AP MLD3 296, all of which can form an ESS (e.g., all AP MLDs which are part of a campus ESS network). The SMD 292 also shows a non-AP MLD1 298 that may be connected to AP MLD1 294.

AP MLD1 294 may include one or more APs such as AP1 and AP2. AP1 and AP2 may be different physical APs (or AP interfaces) co-located in AP MLD1 294. Similarly, AP MLD2 295 may include one or more APs such as AP3 and AP4. AP3 and AP4 may be different physical APs (or AP interfaces) co-located in AP MLD2 295. Similarly, AP MLD3 296 may include one or more APs such as AP5 and AP6. AP5 and AP6 may be different physical APs (or AP interfaces) co-located in AP MLD3 296. The number of AP MLDs and/or the number of respective APs of each AP MLD is not limited to the example numbers shown in FIG. 2B and may include more or less.

In one example, AP MLD1 294, AP MLD2 295, and AP MLD4 296 may be located in different geographical locations (e.g., different rooms of the same building, different floors of the same building, different buildings of the same campus or area, etc.).

Non-AP MLD1 298 may be any known or to be developed device capable of establishing one or more wireless communication links with one or more of AP MLD1 294, AP MLD2 295, and/or AP MLD3 296. As a non-limiting example, non-AP MLD1 298 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of non-AP MLDs and/or STAs associated with each is not limited to that shown in FIG. 2C and may be more or less.

As shown in FIG. 2C, the non-AP MLD1 298 is associated with the SMD 292 with multiple links setup with the AP MLD1 294 (for example, 2.4 GHz link with the AP1 for the STA 1 and 5 GHz link with the AP2 for the STA 2). For one of the links (for example, 2.4 GHZ), the AP MLD1 298 may detect a weak RSSI. As a result, the AP MLD1 298 determines a specific roaming target AP3 of AP MLD2 295 for that link to switch to. Similarly, the same process may be performed for the other link (for example, the 5 GHZ) to switch to a link with STA 4 on the AP MLD2 205.

In order to support seamless link level roaming for an ESS/NID/MDM/SMD (e.g., for MBBR), by way of an example, seamless link level roaming may be initiated by the current AP MLD (e.g., AP MLD1 294). Alternatively, seamless link level roaming may be based upon a request received from the non-AP MLD (e.g., non-AP MLD1 298). The current AP MLD (may also be referred to as the source AP MLD) may send a frame, for example, a BSS Transition Management Request frame or any other known or to be developed management frame, to indicate to the non-AP MLD one or more of: a) one or more ‘delete link’ operations for link(s) of the current AP MLD (in the old MLD's link ID space); and/or b) one or more ‘add link’ operations for link(s) of a new target AP MLD such as the AP MLD2 295 (in the new MLD's link ID space), wherein the current AP MLD may indicate ‘add link’ operations for multiple candidate target AP MLDs.

As described herein, the link space can be defined and identified corresponding to each AP MLD by the respective AP MLD MAC Address field included in the Reconfiguration ML element. Accordingly, the frame, such as the BSS Transition Management Request frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the non-AP MLD1 298 currently creates its association with the ESS network such as the SMD 292, instead of associating with a single AP MLD (e.g., AP MLD1 294, AP MLD2 295, and/or AP MLD3 296) within the ESS. Such an architecture will enable a client to roam seamlessly between AP MLDs without requiring (re) association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

802.11 amendment defines BTM (BSS Transition Management) frame to trigger roaming from the AP side. However, the BTM frame does not support indicating specific link set (one or more links) which are recommended to be added and the link set (one or more links) which are recommended to be deleted by the non-AP MLD. The BTM only provides recommendation for the links or neighboring APs. In 802.11be the BTM was enhanced to add a Basic ML element to indicate recommendation for specific links of an AP MLD.

For network-controlled roaming, it is desirable to enhance BTM so it can be more precise in terms of indicating set of link add and set of link delete operations for a non-AP MLD, when the non-AP MLD is roaming across AP MLDs within a Mobility Domain MLD for Wi-Fi 8, to enable precise network triggered roaming. The signaling procedures described herein include enhancements to the BTM to achieve this objective. Concepts presented herein are not limited to enhancements to BTM frame only and includes making enhancements to any known or to be developed control signaling option which may be pushed in 802.11bn for indicating network triggered roaming across AP MLDs.

FIG. 3 illustrates an example structure of a Neighbor Report element according to some aspects of the present disclosure. As shown in FIG. 3, a management frame such as, the BTM Request frame (not shown in FIG. 3), includes one or more Neighbor Report elements identifying the list of APs which are recommend as roaming candidate in the frame. An example Neighbor Report element (or Neighbor Report Information Element (IE)) may be according to a Neighbor Report element 300 and may identify a neighboring AP which is recommended as a roaming candidate.

The Neighbor Report element 300 includes a list of Optional Sub-Elements 302 in addition to an Element ID field 304, a length field 306, a BSSID field 308, a BSSID Information field 310, an Operating Class field 312, a channel number filed 314, a PHY Type field 316 having their respective length in a number of bytes as shown in FIG. 3. Further, the Element ID field 304 is the first field of the Neighbor Report element 300 followed by the length field 306, the BSSID field 308, the BSSID Information field 310, the Operating Class field 312, the channel number filed 314, the PHY Type field 316, and the list of Optional Sub-Elements 302. The Element ID field 304 has a fixed value, while other fields shown in FIG. 3 have variable values.

The Element ID field 304 identifies a Neighbor Report IE, the length field 306 depends on the number and length of optional sub-elements. Accordingly, a minimum value for the length field may be 13 if no optional sub-elements are present. The BSSID field 308 represents MAC address of an AP client that is being advised to be associated with and the BSSID Information field 310 includes reachability of AP, security, capabilities of AP, mobility domain of the AP indicated by this BSSID. The Operating Class field 312 represents the channel set of the AP indicated by this BSSID. Country, Operating Class, and Channel Number together specify the channel frequency and spacing for the AP indicated by the BSSID field 308. The channel number filed 314 indicates the last known operating channel of the AP indicated by the BSSID field 308, and the PHY Type field 316 indicates the PHY type of the AP indicated by the BSSID field 308.

The list of Optional Sub-Elements 302 is a field having a variable length, and when present, the list of Optional Sub-Elements 302 includes a sub-element ID, a length field specifying length of data, and data field specifying the data. A new element, referenced herein as a Reconfiguration ML element, can be included in the list of Optional Sub-Elements 302. A partial view of the list of Optional Sub-Elements 302 is shown below as Table 1 that includes the Reconfiguration ML element having a sub-element ID value from 202-220.

TABLE 1
Optional Sub-element IDs for Neighbor Report Element

| Sub-element ID | Name | Extensible |
|---|---|---|
| . . . | . . . | . . . |
| 199 | EHT Capabilities | Yes |
| 200 | EHT Operation | Yes |
| 201 | Basic Multi-Link | Yes |
| 202 | Reconfiguration ML Element (Proposed) | Yes |
| . . . | Reconfiguration ML Element (Proposed) | Yes |
| 220 | Reconfiguration ML Element (Proposed) | Yes |

As shown in Table 1, the Reconfiguration ML element may have a value selected from a set of values 202-220. The Reconfiguration ML element may indicate a set of links which are recommended to be deleted for the AP MLD, and/or a set of links that are recommended to be added. The set of links that are recommended to be added is affiliated with a neighboring AP. A specific operation to be performed with reference to the set of links may be specified using the Reconfiguration Operation Type field, as described using Table 2 below.

TABLE 2
Reconfiguration Operation Type (Sub)field Encoding

| Value | Name |
|---|---|
| 0 | AP Removal |
| 1 | Operation Parameter Update |
| 2 | Add Link |
| 3 | Delete Link |
| 4 | NSTR Status Update |
| 5 | Reserved or “Exclude Link” |
| . . . | . . . |
| 15 | Reserved or “Exclude Link” |

In one example, the BTM Request frame can include multiple Neighbor Report elements corresponding to each of those AP MLDs, and each Neighbor Report element can include a Reconfiguration ML element to indicate add link and/or delete link operations for the corresponding AP MLD. As described herein, a sub-element ID for the Reconfiguration ML element may be selected from one of a set of reserved values, e.g., values 202-220.

Additionally, or alternatively, the Reconfiguration ML element included in the Neighbor Report element may also identify one or more links that are preferred to be not added (or excluded) by the non-AP MLD. By way of an example, one or more links may be excluded because the one or more links are overloaded and/or reserved for a specific type of traffic (e.g., high Quality of Service traffic). Similar to the add link and/or the delete link, the exclude link operation may be indicated by a new Reconfiguration Operation type value. By way of an example, as shown in Table 2 above, Reconfiguration Operation Type (sub) field encoding may support values including 0 for AP Removal, 1 for Operation Parameter Update, 2 for Add Link, 3 for Delete Link, 4 for NSTR Status Update, and any value from a set of values including 5-15 may be used to indicate Exclude Link.

Additionally, or alternatively, the Reconfiguration ML element included in the Neighbor Report element may also identify a specific reason code for the recommendation made in the Neighbor Report element. The provided reason code for the recommendation may assist the non-AP MLD to select a target AP MLD for roaming. Further, the add link and/or delete link operations may be signaled using a Basic ML element where a link that is included may be interpreted as signaled for an add link operation with respect to the AP MLD, and other links of the same AP MLD are interpreted to be excluded or deleted.

For example, for a network triggered roaming for a non-AP MLD, an AP MLD 1 can signal to delete a link link1 with the AP MLD 1 and add a link link2 with AP MLD 2 in a BTM Request frame. The non-AP MLD, upon receiving a BTM Request frame with a Reconfiguration ML element(s) indicating add and/or delete link operations, initiates link reconfiguration as per the add/delete link operations indicated by the Reconfiguration ML element(s) in the BTM Request frame.

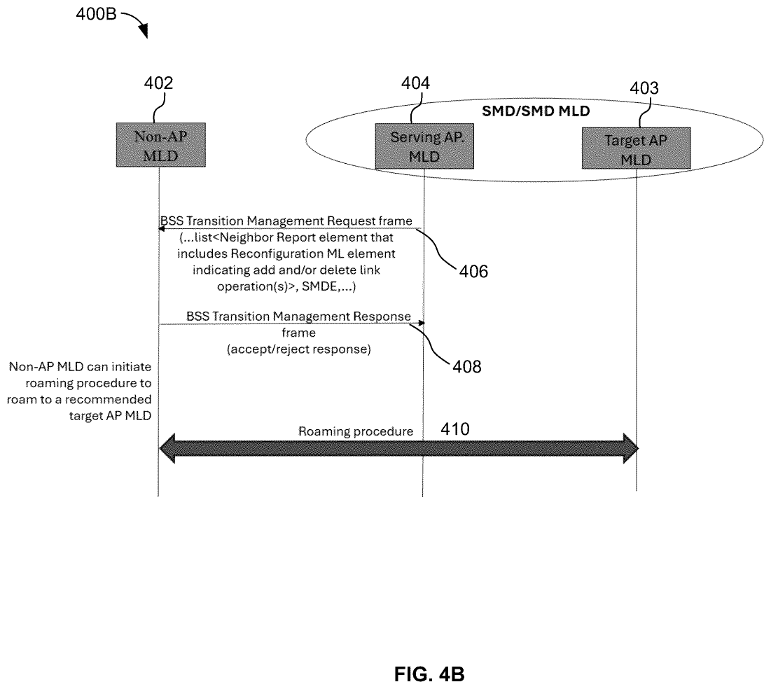

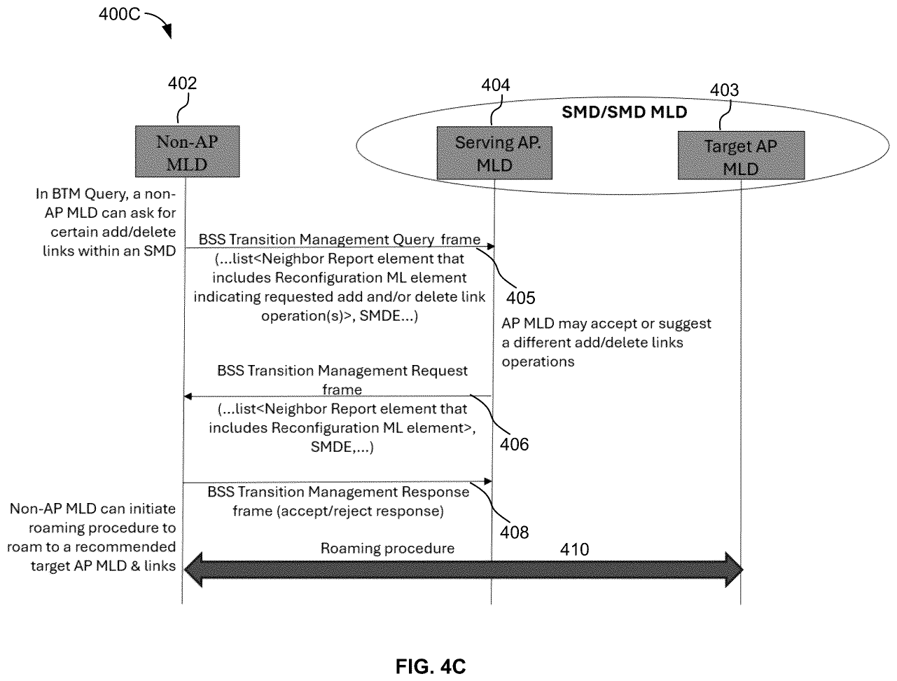

FIGS. 4A-4C each illustrates an example event trace diagram according to some aspects of the present disclosure. For example, in FIG. 4A, an event trace diagram 400A shows frames communicated between a non-AP MLD 402 and an AP MLD 404. The AP MLD 404 may send to the non-AP MLD 402 a management frame such as, the BTM Request frame 406. The BTM Request frame 406 may include one or more Neighbor Report elements identifying the list of APs which are recommend as roaming candidate in the BTM Request frame 406. An example Neighbor Report element may be according to a Neighbor Report element format shown in FIG. 3 and may identify a neighboring AP 403.

The neighboring AP 403 is shown in an event trace diagram 400B in FIG. 4B as a target AP MLD, which may be a recommended roaming candidate. Upon receiving the BTM Request frame 406, the non-AP MLD 402 sends a management frame such as, the BTM Response frame 408 indicating whether the non-AP MLD 402 accepts or rejects the requested roaming recommendations. If the non-AP MLD accepts the requested roaming recommendations, the non-AP MLD performs the roaming procedure 410, as requested in the BTM request frame, to the indicated target AP MLD such as AP MLD 404.

Further, in some aspects, as shown in an event trace diagram 400C in FIG. 4C, the non-AP MLD 402 may request the AP MLD 404 for a certain add link and/or delete link operations within the SMD. The non-AP MLD 402 may send a BTM Query frame 405 to the AP MLD 404. The BTM Query frame 405 includes a Reconfiguration ML element which identifies the requested add link operation and/or delete link operation. Upon receipt of the BTM Query frame 405, the AP MLD 404 may send the BTM Request frame 406, as described herein, for the non-AP MLD 402 to perform the requested roaming operations.

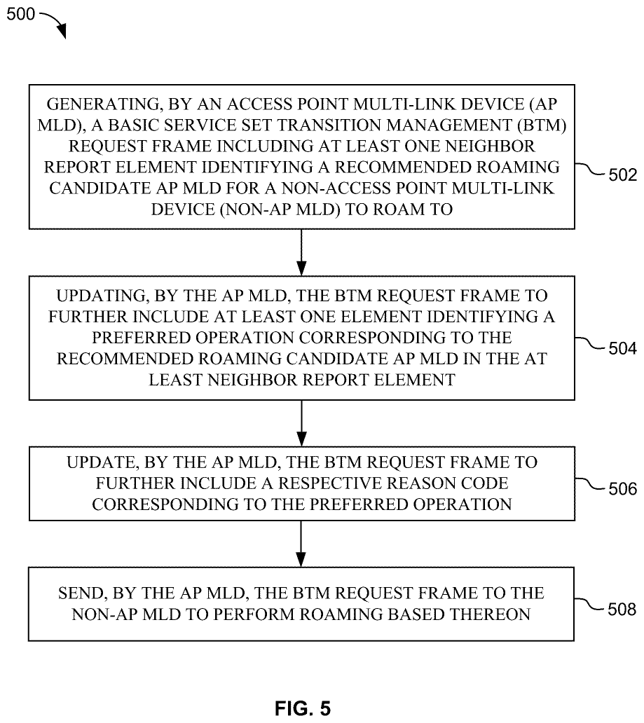

FIG. 5 illustrates an example flow-chart 500 of method operations according to some aspects of the present disclosure. The method operations include generating 502, by an access point multi-link device (AP MLD) such as AP MLD 270 (shown in FIG. 2B), a basic service set transition management (BTM) request frame including at least one neighbor report element in the list of Optional Sub-Elements 302 (shown in FIG. 3). The at least one neighbor report element identifies a recommended roaming candidate AP MLD for a non-AP MLD (e.g., Non-AP MLD 272) to roam to. The method operations include updating 504, by the AP MLD, the BTM request frame to further include at least one element identifying at least one preferred operation corresponding to the recommended roaming candidate AP MLD in the at least neighbor report element.

As described herein, the at least one preferred operation may correspond to an add link action for adding a respective link associated with the AP MLD or another AP MLD, a delete link action for deleting a respective link associated with the AP MLD or another AP MLD, and/or an exclude link action that indicates excluding a respective link associated with the AP MLD or another AP MLD for roaming. Further, the preferred operation may be indicated in Reconfiguration Operation Type (sub) field encoding field of a reconfiguration multi-link element included in the at least one neighbor report element. A value for the preferred operation may be 0 for AP Removal, 1 for Operation Parameter Update, 2 for Add Link, 3 for Delete Link, 4 for NSTR Status Update, and any value from 5-15 or any unused value for Exclude Link operations, as shown in Table 2 above. As described herein, the recommended roaming candidate AP MLD and the AP MLD both belong to the same seamless mobility domain.

Additionally, the method operations include updating 506, by the AP MLD, the BTM request frame to further include a respective reason code corresponding to the at least one preferred operation. The reason code may assist the non-AP MLD to select a target AP MLD for roaming. The reason code may identify whether one or more links are overloaded or reserved for a specific type of traffic (e.g., high Quality of Service traffic). The method operations include sending 508, by the AP MLD, the BTM request frame to the non-AP MLD to perform roaming based thereon. Upon receiving the BTM request frame, the non-AP MLD may accept or reject the requested roaming recommendations. If the non-AP MLD accepts the requested roaming recommendations, the non-AP MLD performs the roaming procedure, as requested in the BTM request frame, to the indicated target AP MLD.

Further, the BTM request frame may be generated based upon receiving, by the AP MLD from the non-AP MLD, a BTM query frame including at least one neighbor report element identifying a preferred roaming candidate AP MLD, and at least one optional element such as, a Reconfiguration ML element, identifying at least one preferred operation such as, add link, delete link, and/or exclude link, corresponding to the preferred roaming candidate AP MLD and/or the AP MLD. The at least one neighbor report element is having a value selected from a set of values including a first value through a second value, or any unused value, wherein the first value is 202 and the second value is 220, as described herein with reference to Table 1. The at least one neighbor report element is Reconfiguration Multi-link element. In other words, the non-AP MLD may request the AP-MLD for a certain add link and/or delete link operations within the SMD. The non-AP MLD may send a BTM Query frame to the AP-MLD. The BTM Query frame includes a Reconfiguration ML element which identifies the requested add link operation and/or delete link operation. Upon receipt of the BTM Query frame, the AP-MLD may send the BTM Request frame, as described herein, for the non-AP MLD to perform the requested roaming operations.

Accordingly, various aspects disclosed herein enhance a management frame such as, the BTM frame by adding a Basic ML element to indicate recommendation for specific links of an AP MLD to be added and/or deleted by the non-AP MLD when the non-AP MLD is roaming across AP MLDs within a Mobility Domain MLD.

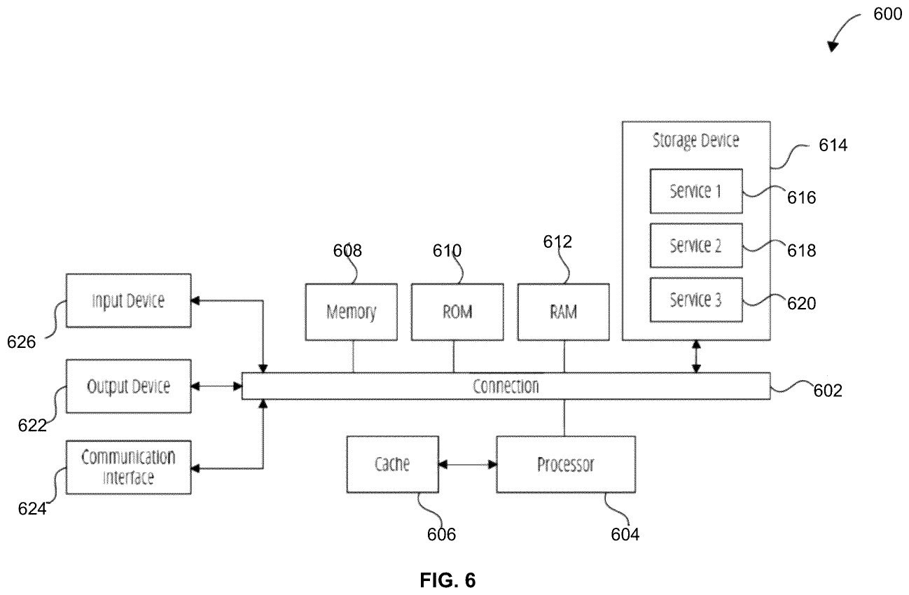

FIG. 6 shows an example of computing system 600, which can be for example any computing device making up the elements of FIG. 1, FIG. 2A-C, FIG. 3, FIG. 4A. FIG. 4B, FIG. 4C, and FIG. 5, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU) or processor such as processor 604 and connection 602 that couples various system components including system memory 608, such as read-only memory (ROM) such as ROM 610 and random-access memory (RAM) such as RAM 612 to processor 604. Computing system 600 can include a cache of high-speed memory 606 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a STA device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
generating, by an access point multi-link device (AP MLD), a basic service set transition management request frame (BTM request frame) including at least one neighbor report element identifying a recommended roaming candidate AP MLD for a non-access point multi-link device (non-AP MLD) to roam to;
updating, by the AP MLD, the BTM request frame to further include at least one element identifying at least one preferred operation corresponding to the recommended roaming candidate AP MLD in the at least one neighbor report element; and
sending, by the AP MLD, the BTM request frame to the non-AP MLD to perform roaming based thereon.

2. The method of claim 1, wherein the at least one preferred operation corresponds to an add link action for adding a respective link associated with the AP MLD or another AP MLD.

3. The method of claim 1, wherein the at least one preferred operation corresponds with a delete link action for deleting a respective link associated with the AP MLD or another AP MLD.

4. The method of claim 1, wherein the at least one preferred operation corresponds with an exclude link action that indicates excluding a respective link associated with the AP MLD or another AP MLD for roaming.

5. The method of claim 1, wherein the at least one preferred operation is specified in a reconfiguration operation type (sub) field of a reconfiguration multi-link element included in the at least one neighbor report element, and wherein the recommended roaming candidate AP MLD and the AP MLD both belong to a seamless mobility domain.

6. The method of claim 1 further comprising:
updating, by the AP MLD, the BTM request frame to further include a respective reason code corresponding to the at least one preferred operation.

7. The method of claim 1, wherein,
the BTM request frame is generated based upon receiving, by the AP MLD from the non-AP MLD, a BTM query frame including at least one neighbor report element identifying a preferred roaming candidate AP MLD, and at least one optional element identifying at least one preferred operation corresponding to the preferred roaming candidate AP MLD,
the at least one preferred operation is specified in a reconfiguration operation type (sub) field using a value from 5 to 15, or any unused value, and
the at least one neighbor report element is having a value selected from a set of values including a first value through a second value, or any unused value, wherein the first value is 202 and the second value is 220, wherein the at least one neighbor report element is Reconfiguration Multi-link element.

8. An access point multi-link device (AP MLD) comprising:
at least one memory configured to store computer-readable instructions; and
at least one processor communicatively coupled with the at least one memory and configured to execute the computer-readable instructions to:
generate a basic service set transition management request frame (BTM request frame) including at least one neighbor report element identifying a recommended roaming candidate AP MLD for a non-access point multi-link device (non-AP MLD) to roam to;
update the BTM request frame to further include at least one element identifying at least one preferred operation corresponding to the recommended roaming candidate AP MLD in the at least one neighbor report element; and
send the BTM request frame to the non-AP MLD to perform roaming based thereon.

9. The AP MLD of claim 8, wherein the at least one preferred operation corresponds to an add link action for adding a respective link associated with the AP MLD or another AP MLD.

10. The AP MLD of claim 8, wherein the at least one preferred operation corresponds with a delete link action for deleting a respective link associated with the AP MLD or another AP MLD.

11. The AP MLD of claim 8, wherein the at least one preferred operation corresponds with an exclude link action that indicates excluding a respective link associated with the AP MLD or another AP MLD for roaming.

12. The AP MLD of claim 8, wherein the at least one preferred operation is specified in a reconfiguration operation type (sub) field of a reconfiguration multi-link element included in the at least one neighbor report element, and wherein the recommended roaming candidate AP MLD and the AP MLD both belong to a seamless mobility domain.

13. The AP MLD of claim 8, wherein the at least one processor is further configured to execute the computer-readable instructions to update the BTM request frame to further include a respective reason code corresponding to the at least one preferred operation.

14. The AP MLD of claim 8, wherein:
the BTM request frame is generated based upon a BTM query frame received from the non-AP MLD, wherein the BTM query frame includes at least one neighbor report element identifying a preferred roaming candidate AP MLD, and at least one optional element identifying at least one preferred operation corresponding to the preferred roaming candidate AP MLD;
the at least one preferred operation is specified in a reconfiguration operation type (sub) field using a value from 5 to 15 or any unused value;
the at least one neighbor report element is having a value selected from a set of values including a first value through a second value, or any unused value;
the first value is 202 and the second value is 220; and
the at least one neighbor report element is Reconfiguration Multi-link element.

15. A non-transitory computer-readable media comprising computer-readable instructions stored thereon, which, when executed by at least one processor of an access point multi-link device (AP MLD), cause the AP MLD to:
generate a basic service set transition management request frame (BTM request frame) including at least one neighbor report element identifying a recommended roaming candidate AP MLD for a non-access point multi-link device (non-AP MLD) to roam to;
update the BTM request frame to further include at least one element identifying at least one preferred operation corresponding to the recommended roaming candidate AP MLD in the at least one neighbor report element; and
send the BTM request frame to the non-AP MLD to perform roaming based thereon.

16. The non-transitory computer-readable media of claim 15, wherein the at least one preferred operation corresponds to an add link action for adding a respective link associated with the AP MLD or another AP MLD.

17. The non-transitory computer-readable media of claim 15, wherein the at least one preferred operation corresponds with a delete link action for deleting a respective link associated with the AP MLD or another AP MLD.

18. The non-transitory computer-readable media of claim 15, wherein the at least one preferred operation corresponds with an exclude link action that indicates excluding a respective link associated with the AP MLD or another AP MLD for roaming.

19. The non-transitory computer-readable media of claim 15, wherein execution of the computer-readable instructions further cause the AP MLD to update the BTM request frame to further include a respective reason code corresponding to the at least one preferred operation.

20. The non-transitory computer-readable media of claim 15, wherein the at least one preferred operation is specified in a reconfiguration operation type (sub) field using a value from 5 to 15, or any unused value.
